(19) United States
(12) Patent Application Publication
(10) Pub. No.: US 2016/0106094 A1
(43) Pub. Date: Apr. 21, 2016

(54) CONCENTRATED AGRICULTURAL COMPOSITION

(71) Applicant: AKZO NOBEL CHEMICALS INTERNATIONAL B.V., Amersfoort (NL)

(72) Inventors: Marcos Antonio Rodrigues Oliveira, São Paulo (BR); Natalia Goncalves, São Paulo (BR)

(73) Assignee: Akzo Nobel Chemicals International B.V., Amersfoort (NL)

(21) Appl. No.: 14/779,721

(22) PCT Filed: Mar. 24, 2014
(86) PCT No.: PCT/EP2014/055785

§ 371 Date: Sep. 24, 2015

Related U.S. Application Data
(60) Provisional application No. 61/805,313, filed on Mar. 26, 2013.

(30) Foreign Application Priority Data
Mar. 26, 2013 (EP) 13161152.7

(51) Int. Cl. A01N 25/30; A01N 25/02; A01N 43/653; A01N 47/30; A01N 43/70

(52) U.S. Cl. CPC A01N 25/30; A01N 47/30; A01N 43/70; A01N 43/653; A01N 25/02

(57) ABSTRACT

A concentrated agriculturally active composition is provided, comprising from 5 to 40 wt %, of least one agriculturally active ingredient having a water solubility of at most 1 g/l; at least 20 wt % of at least one cationic surfactant; from 0.1 to 50 wt % of at least one organic solvent, and optionally further agriculturally acceptable additives, wherein the weight ratio of the at least one agriculturally active ingredient to the at least one cationic surfactant is at most 1:2.

### FIELD OF INVENTION

The present invention relates to a concentrated agriculturally composition comprising an agriculturally active ingredient and a quaternary ammonium surfactant.

### BACKGROUND OF INVENTION

Agricultural actives, such as pesticides and plant growth regulators, have conventionally been provided to the end-user in different concentrated forms to be diluted in water or other suitable medium to a dilute ready-to-use formulation by the end-user. Such concentrated forms include solid formulations, e.g. powders, and liquid formulations. In many applications, liquid formulations are preferred as problems of dusting of toxic powders and slow dissolution in the diluent may be avoided.

The liquid concentrated formulations include so-called emulsion concentrates and soluble liquid concentrates. An emulsion concentrate comprises an agricultural active, a water-insoluble solvent, and an emulsifier, and when added to the water, it spontaneously, or after mixing, forms an oil-in-water emulsion, the agricultural active primarily being present in the emulsion droplets. This type of concentrated formulation is especially suitable for agricultural actives that are water insoluble/have low water solubility, and where the recommended concentration in the ready-to-use formulation exceeds the solubility of the agricultural active.

It is important that the active ingredient is stably dissolved in the emulsion concentrate. Precipitation of the agriculturally active ingredient upon dilution in water may result in a loss of efficacy. Should the active ingredient be concentrated to the precipitates, it is prevented from being evenly distributed when sprayed on a field. Uneven distribution of the agriculturally active ingredient may cause phytotoxicity.

WO 2010/051607 relates to concentrates of biologically active substance that are dispersible in water, that upon dispersion in water returns a dispersion with a particle size distribution of less than 400 nm, typically in the order of 180 nm.

However there is still a need in the art to provide improved concentrated agriculturally active compositions that stable and easily produced and that ensure, when used properly, the even distribution of the agricultural active ingredients.

### SUMMARY OF INVENTION

One object of the invention is to at least partially meet the needs in the art. The present inventors have found that this can be obtained by compositions as defined in the appended claims, by solubilising the agriculturally active ingredients in quaternary ammonium surfactants and optionally, organic solvents.

In one aspect, the invention relates to a concentrated agricultural composition. The concentrated agricultural composition is in the form of a solution and no milling process is required to obtain the concentrated composition of the present invention. The agriculturally active ingredient is easily solubilized by simple mechanical stirring, if needed facilitated by the slight heating of the solution from 30° C. to 70° C. during the stirring, and subsequent return to ambient temperature and no crystallization is observed.

In another aspect, the invention relates to a diluted, ready-to-use, agricultural composition formed by mixing the concentrated agricultural composition with water. The ready-to-use composition is typically completely translucent. The agriculturally active ingredient can be completely solubilized in water to prepare the ready-to-use solution due to the formulation composition developed. The agriculturally active ingredient is solubilized in the water by means of formation of a thermodynamically stable and translucent micro emulsion, different from ordinary emulsions and dispersions commonly used in agriculture.

In yet another aspect, the invention relates to a method for treating a plant by contacting the plant with a ready-to-use agricultural composition of the invention.

These and other aspects and advantages of the invention will be apparent from the description of the invention set out below.

### DESCRIPTION OF THE INVENTION

A concentrated agricultural composition of the invention comprises from 5 to 40 wt %, preferably from 10 to 35 wt %, based on the total weight of the composition, of least one agriculturally active ingredient having a water solubility of at most 1 g/l.

The term “agriculturally active ingredient” as used herein is to be taken as encompassing any organic compound being agriculturally active. The agriculturally active ingredients contemplated for use in the present invention, also referred to in the art as agricultural actives, are preferably selected from the group consisting of pesticides and plant growth regulators.

The agriculturally active ingredients are selected amongst those having a solubility of most 1 g/l, for example at most 0.7 g/l in water. In the context of the present invention, water solubility is measured according to ASTM E 1148-87 “Standard Test Method for Measurements of Aqueous Solubility”.

Preferably, the agriculturally active ingredient is among those whose recommended end use concentration is above its solubility in water.

As used herein, the term “pesticide” refers to a compound that will prevent, destroy, repel, or mitigate any pest.

As used herein, the term “plant growth regulator” refers to a compound, which through physiological action will accelerate or retard the rate of growth or rate of maturation or otherwise alter the behaviour of ornamental or crop plants or the products thereof.

Pesticides and plant growth regulators especially contemplated for use in the present invention are organic compounds, preferably synthetic organic compounds.

Pesticides contemplated for use in the present invention include, fungicides, herbicides, insecticides, miticides, nematicides, acaricides, and molluscicides.

Preferred agriculturally active ingredients contemplated for use in the present invention include pesticides and plant growth regulators of the classes triazoles, strobilurins, alkylenebis(dithiocarbamate) compounds, benzimidazoles, phenoxy carboxylic acids, benzoic acids, ureas, sulfonylureas, triazines, pyridine carboxylic acids, neonicotinides, amidines, organophosphates, and pyrethroids.

Examples of fungicides contemplated for use in the present invention include fungicides of the classes triazoles (e.g. tebuconazole, tetraconazole, cyproconazole, epoxiconazole, difenconazole, propiconazole, prothioconazole, myclobutanil), strobilurins (e.g. trifloxystrobin, azoxystrobin, fluoxastrobin, pyraclostrobin), alkylenebis(dithiocarbamate) compounds (e.g. mancozeb) and benzimidazoles (e.g carbendazim).

Examples of herbicides contemplated for use in the present invention include phenoxy carboxylic acids (e.g. 2,4-D-acid, MCPA), benzoic acids (e.g. Dicamba-acid), ureas, (e.g. Diuron) sulfonylureas (e.g. methylsulfuron-methyl, rimsulfuron), triazines (e.g. atrazine, simazine, ametryn), triazolinones (e.g. amicarbazone) and pyridine carboxylic acids (e.g. triclopyr).

Examples of insecticides contemplated for use in the present invention include neonicotinides (e.g. thiamethoxam, clothianidin, thiacloprid, dinotefuran, acetamiprid, nitenpyram, imidacloprid), amidines (e.g. amitraz), organophosphates (e.g. chlorpyrifos) and pyrethroids (e.g. permethrin, bifenthrin, deltamethrin).

Examples of plant growth regulators contemplated for use in the present invention include, but are not limited to, phosphonic acids (e.g. ethephon), gibberellins cytokinins (e.g. 6-benzylaminopurine) and auxins (e.g. 1-naphtylacetic acid).

For a detailed description of each of the above-mentioned pesticides and plant growth regulators, reference is made to handbooks, e.g. “The e-Pesticide Manual v4.0” from BCPC Publications Ltd, Alton, Hampshire. (ISBN 1 901396 42 8).

A concentrated composition of the invention further comprises at least one quaternary ammonium based surfactant at a concentration of at least 20, preferably at least 30, more preferably at least 40 wt %, based on the total weight of the composition. The weight ratio of the at least one agriculturally active ingredient to the at least one quaternary ammonium based surfactant is at most 1:2, preferably at most 1:3, more preferably at most 1:4.

Typically the concentration of the quaternary ammonium surfactant is from 20, preferably from 30, more preferably from 40, to 80, preferably to 70 wt %, based on the total weight of the composition.

The quaternary ammonium based surfactant is a surface active compound comprising at least one hydrophobic group and at least one quaternary ammonium group, and is preferably is according to any one of the formulas (I) and (II) below, or combinations thereof.

The quaternary ammonium based surfactant may be an ethoxylated quaternary ammonium surfactant, such as a compound according to formula I:

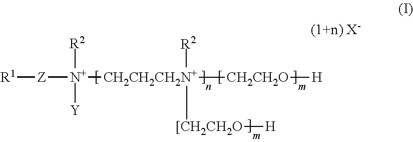

wherein:
each m is at least 1 and the sum of all m (Σm) is from 1, preferably from 2, more preferably from 5, most preferably from 10, to 200, preferably to 50, more preferably to 30, most preferably to 20 n is an integer from 0 to 2, preferably 0 or 1;

R¹ is a C₅ to C₂₃-hydrocarbyl, preferably a saturated or unsaturated linear hydrocarbyl group Z is a carbon atom, a group —C—O—CH₂CH₂CH₂— or a group —C(═O)—N—CH₂CH₂CH₂—, preferably a carbon atom;

R² is methyl, ethyl or benzyl, preferably methyl;

Y is a hydrocarbyl group having 1-24 carbon atoms, preferably methyl, benzyl, or R1-Z where Z is a carbon atom, or a group (CH₂CH₂O)ₘH; and

X⁻ is an anion, for example a halide anion, such as Cl⁻, NO₂⁻ or an monoalkylsulfate, or any other anion acceptable for use in agricultural compositions.

Preferably, Z is a carbon atom and R¹—Z— represents the alkyl or alkenyl group derived from a natural or synthetic fatty alcohol of formula R¹—Z—OH, or from the corresponding fatty acid of formula R¹—COOH. Examples include the alkyl or alkenylgroups from synthetic sources, such as from OXO-alcohols, Guerbet-alchols as well as naturally occurring sources, such as from fatty acids such as from coconut oil, tallow, hydrogenated tallow, rapeseed oil, sunflower oil, etc.

Examples of quaternary ammonium based surfactant of formula I include ethoxylated and quaternized fatty mono, di- or tri amines, such those available from Akzo Nobel under the tradenames Ethoquad and Ethoduoquad, ethoxylated and quaternized fatty ether mono-, di- or tri amines, and ethoxylated and quaternized fatty amidopropyl mono-, di- and tri amines.

The quaternary ammonium based surfactant may alternatively be a quaternary ammonium compound of formula (II)

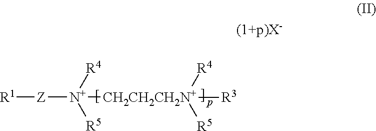

where R1, Z, R1-Z— and X are as defined above for formula (I);

R³ is a C₁-C₂₄ hydrocarbyl, preferably methyl or the group R¹—Z— where Z is a carbon atom;

R⁴ and R⁵ independently are selected from methyl, ethyl or benzyl, and preferably at most one of R⁴ and R⁵ is a benzyl group; and
p is 0 or 1, preferably 0

Examples of quaternary ammonium based surfactant of the formula (II) includes those where R¹—Z— is a C₆ to C₂₄ alkyl, R¹, R² and R³ are methyl and p is 0 or 1, those where R¹—Z and R³ are C₆-C₂₄ alkyl and R⁴ and R⁵ is methyl, and those where R¹—Z— is a C₆-C₂₄-alkyl, R³ and R⁴ are methyl and R⁵ is benzyl.

Quaternary ammonium compounds of formula (I) and formula (II) may be present simultaneously in the compositions of the invention.

A concentrated agricultural composition of the invention optionally contains at least one water-insoluble organic solvent, at a concentration of from 0.1, preferably from 1, more preferably from 10, even more preferably from 20, to 50, preferably to 40, more preferably to 35 wt %, based on the total weight of the composition.

In the context of the present invention, a solvent is considered water-insoluble if its water solubility is less than 10, preferably less than 5, more preferably less than 1, most preferably less than 0.1 g/litre water at 20° C.

For example, such water-insoluble solvent may be selected from the group consisting of aromatic solvents such as those sold under the tradename of Solvesso, water-insoluble alcohols, such as linear or branched, aliphatic or aromatic, saturated or unsaturated alcohols with at least 6 carbon atoms, for example as from 6 to 24 carbon atoms, examples of which include hexanols, heptanols and fatty alcohols, and water-insoluble amides of formula (III)

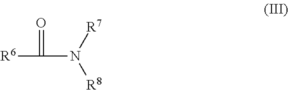

where
R⁶ is H or a C1 to C23 hydrocarbyl, the hydrocarbyl preferably being a linear or branched alkyl or alkenyl;
R⁷ and R⁸ independently is a C₁ to C₂₄ hydrocarbyl, the hydrocarbyl preferably being benzyl or a linear or branched alkyl or alkenyl, and the total number of carbon atoms in the amide of formula (III) is at least 10.

When at least one of R⁷ and R⁸ contains more than 6 carbon atoms, then R⁶ is preferably H, CH₃ or C₂H₅, most preferably H. Exemplary compounds include those where R⁶ is H, R⁷ is methyl or benzyl and R⁸ is n-octyl, 2-ethylhexyl, n-decyl or 2-propylheptyl.

R⁶ is preferably a C₅ to C₂₃ hydrocarbyl, more preferably a C₇ to C₁₁ hydrocarbyl, when R⁷ and R⁸ each contain less than 4 carbon atoms, for example where R⁷ and R⁸ is methyl and R⁶—C(═O) is n-octanoyl, 2-ethyl-hexanoyl, n-decanoyl or 2-propylheptanoyl. A concentrated agricultural composition of the invention may, in addition to the agriculturally active ingredient, the quaternary ammonium based surfactant and the organic water-insoluble solvent, and when the total content of the aforementioned components does adds up to a total of less than 100 wt %, further comprise additional components, such as other surfactants, water, thickeners, deposition enhancers, drift control agents, salts, etc, constituting the balance of the composition.

Water may be present in the concentrated composition at a concentration of from 0 to 65, preferably to 40, more preferably to 20, even more preferably to 10, most preferably to 5 wt %, based on the total weight of the composition. Most preferably the concentrated composition is completely or essentially free from water.

Surfactants other than quaternary ammonium based surfactants, such as anionic, non-ionic, non-quaternized amine surfactants, amphoteric, and zwitterionic surfactants, may present in the concentrated composition at a concentration of from 0 to 40, preferably to 20 wt %, based on the total weight of the composition.

Polymers, such as polysaccharide ethers and synthetic polymers, may be included in the concentrated composition, as thickeners, deposition enhancers, drift control agents, etc.

The concentrated composition of the present invention provides a formulation with a high concentration of the agriculturally active, suitable for long term storage and delivery to the end used, who eventually will treat plants by contacting the plant with an agricultural formulation prepared from the concentrated composition of the invention.

Water-soluble organic solvents, such as glycol ethers, such as butyl diglycol, N-formyl-morpholine, shorter aliphatic alcohols, propylene carbonate, etc. may be present in the composition of the invention, at a weight ratio water-soluble organic solvent:water-insoluble organic solvent of at most 1:2.

The concentrated composition of the invention is preferably in liquid form at room temperature and atmospheric pressure, with the agriculturally active ingredient solubilised therein.

The concentrated composition of the invention is intended to be mixed with an aqueous medium, typically tap water, before end use. The concentrated composition is added to a tank, before, simultaneously with or after, addition of the aqueous medium (water) to the tank. The concentrated composition of the invention is therewith diluted to a suitable concentration of the agriculturally active.

The water content in the diluted composition of the invention is typically in the range of from 75, preferably from 90, to 99.99 based on the total weight of the diluted composition, and will ultimately depend on the amount of water needed to dilute the agriculturally active ingredient in the concentrated composition of the invention to the desired concentration in the ready-to-use composition.

When mixed with and diluted in the aqueous medium, the agriculturally active is evenly distributed in the aqueous medium, in the form of a solution or a fine emulsion, and can be diluted substantially without any crystal growth occurring.

Plants are treated with the diluted, ready-to-use composition of the invention by contacting the plant to be treated with the diluted composition in any manner conventionally used. As used herein, the term “plant” refers not only to the stem, leave and fruit of the plant, visible above ground, but also to the roots as well as seeds. The amount of active ingredient contacted with the plant is preferably sufficient for the active ingredient to exercise its pesticidal or plant growth regulating activity, i.e. an effective amount.

Preferably, the plant is contacted with the diluted, ready-to-use composition of the invention by means of spraying, but also dipping the plant in the composition is contemplated.

### Examples

### Materials

In the examples the following materials have the meaning set out below:
Armid DM 810 mixture of N,N-dimethyl-octanamide and N,N-dimethyl-decanamide (ex Akzo Nobel)
Armid FMPC A solvent blend based on a morpholine derivative (ex Akzo Nobel)
Arquad MCB 80 Benzyl dimethyl cocoalkyl ammonium chloride (ex Akzo Nobel)
Ethoquad T/25 Tallow alkyl methyl [ethoxylated (15)] ammonium chloride (ex Akzo Nobel)
Adsee AB 650 blend of a modified fatty amine polymer with a sugar based surfactant (ex Akzo Nobel)

Solvent Composition 1

| Material | |
|---|---|
| Arquad MCB 80 | 65 wt % |
| Armid DM 810 | 35 wt % |
| Total | 100 wt % |

Solvent Composition 2

| Raw material | |
|---|---|
| Ethoquad T/25 | 70 wt % |
| Armid DM 810 | 30 wt % |
| Total | 100 wt % |

Solvent composition 3

| Raw material | |
|---|---|
| Arquad MCB 80 | 70 wt % |
| Armid DM 810 | 20 wt % |
| Butyl digylcol | 10 wt % |
| Total | 100 wt % |

Solvent Composition 4

| Raw material | |
|---|---|
| Arquad MCB 80 | 60 wt % |
| Armid DM 810 | 28 wt % |
| Armid FMPC | 12 wt % |
| Total | 100 wt % |

Concentrated Composition 1 (100 g/l Diuron)

| | | |
|---|---|---|
| A.I. (Active Ingredient) | Diuron (purity 98.2%) | 10.31 g |
| Solvent Composition | 1 | 89.69 g |
| Total | | 100 g |

Concentrated Composition 2 (100 g/l Ametryn)

| | | |
|---|---|---|
| A.I. (Active Ingredient) | Ametryn (purity 97%) | 10.61 g |
| Solvent Composition | 1 | 89.39 g |
| Total | | 100 g |

Concentrated Compositions 1 and 2 was obtained by adding the quaternary ammonium surfactant into a vessel and adding the organic solvent under agitation and at room temperature. Thereafter, the active ingredient was added under continued agitation, which was continued until the active ingredient was fully dissolved, and the composition was clear and homogenous as judged by ocular inspection.

Concentrated Composition 3 (200 g/l Myclobutanil)

| | | |
|---|---|---|
| A.I. (Active Ingredient) | Myclobutanil (purity 93%) | 20.39 g |
| Solvent Composition | 2 | 69.61 g |
| Additional components | Adsee AB 650 | 10.00 g |
| Total | | 100 g |

Concentrated Compositions 3 was obtained by adding the quaternary ammonium surfactant into a vessel and adding the organic solvent under agitation and at room temperature. Thereafter, the active ingredient was added under continued agitation and heating to about 60° C. The agitation was continued until the active ingredient was fully dissolved, and the composition was clear and homogenous as judged by ocular inspection. The additional components were added under agitation until complete homogenisation.

Concentrated Composition 4 (100 g/l Tebuconazol)

| | | |
|---|---|---|
| A.I. (Active Ingredient) | Tebuconazol (purity 98.2%) | 10.40 g |
| Solvent Composition | 3 | 74.60 g |
| Additional components | Adsee AB 650 | 15.00 g |
| Total | | 100 g |

Concentrated Composition 5 (150 g/l Tebuconazol)

| | | |
|---|---|---|
| A.I. (Active Ingredient) | Tebuconazol (purity 95%) | 15.6 g |
| Solvent Composition | 4 | 84.4 g |
| Total | | 100 g |

Concentrated Compositions 4 and 5 was obtained by adding the quaternary ammonium surfactant into a vessel and adding the organic solvent under agitation and at room temperature. Thereafter, the active ingredient was added under continued agitation. The agitation was continued until the active ingredient was fully dissolved, and the composition was clear and homogenous as judged by ocular inspection. Additional components were added under agitation until complete homogenisation.

The concentrated compositions 1 to 5 were stored at 5° C. and 54° C. All concentrated compositions remained stable for 30 days in both conditions (no crystals or phase separation were observed).

Ready-to-use solutions were prepared by adding 95 ml of standard water and 5 ml of the concentrated composition into a test tube of 100 ml. The test tube was inverted 30 times and a translucent solution was formed.

The procedure was repeated with each concentrated composition 1 to 5 described above and changing the hardness of water. Standard waters of 20 ppm, 342 ppm and 1000 ppm of hardness were prepared according to CIPAC MT 18 and used in the test.

The ready to use solutions were left at 25° C. and 5° C. for 3 hours and no crystals formation was observed.

1. A concentrated agriculturally active composition, comprising
a) 5 to 40 wt % of least one agriculturally active ingredient having a water solubility of at most 1 g/l;
b) at least 20 wt % of at least one quaternary ammonium surfactant; and
c) 0.1 to 50 wt % of at least one organic water-insoluble solvent.

2. A composition according to claim 1, comprising
a) 10 to 35 wt % of the least one agriculturally active ingredient
b) at least 40 wt % of the at least one quaternary ammonium surfactant; and
c) 20 to 40 wt % of the at least one water-insoluble organic solvent.

3. A composition according to claim 1, wherein the weight ratio of the at least one agriculturally active ingredient to the at least one cationic surfactant is at most 1:2.

4. A composition according to claim 1, comprising at most 20 wt % water.

5. A composition according to claim 1, comprising at most 40 wt % surfactants other than quaternary ammonium surfactants.

6. A composition according to claim 1, which is a liquid at a temperature of 20° C. and a pressure of 1 atm.

7. A composition according to claim 1, wherein said agriculturally active ingredient is a plant growth regulator or a pesticide.

8. A composition according to claim 1, wherein said at least one pesticide is selected from the list consisting of herbicides, insecticides, molluscicides, acaricides, fungicides and combinations thereof.

9. A composition according to claim 1, wherein said quaternary ammonium surfactant is selected from the group consisting of ethoxylated ammonium compounds of formula (I) 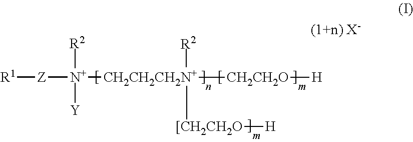
wherein
each m is at least 1 and the sum of all m (Σm) is from 1 to 200;
n is an integer from 0 to 2;
R¹ is a hydrocarbyl having 5 to 23 carbon atoms;
Z is a carbon atom, a group —C—O—CH₂CH₂CH₂— or a group —C(═O)—N—CH₂CH₂CH₂—,
R² is methyl, ethyl or benzyl;
Y is a hydrocarbyl group having 1-24 carbon atoms, benzyl or a group (CH₂CH₂O)ₘH; and
X⁻ is an anion;
quaternary ammonium compounds of formula (II) 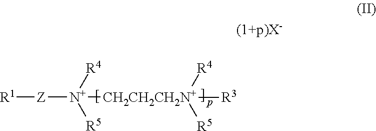
where R¹ and Z is as defined for formula (I),
R³ is a hydrocarbyl having 1 to 24 carbon atoms;
R⁴ and R⁵ independently are selected from methyl, ethyl or benzyl; and
p is 0 or 1;
or mixtures thereof.

10. A composition according to claim 1, wherein said at least one organic water-insoluble solvent is selected from the group consisting of aromatic solvents, alcohols, amides and combinations thereof.

11. A composition according to claim 1, wherein said organic solvent comprises an amide of formula (III) 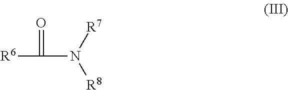
where:
R⁶ is H or a C₁ to C₂₃ hydrocarbyl;
R⁷ and R⁸ independently is a C₁ to C₂₄ hydrocarbyl; and
the total number of carbon atoms in the amide of formula (III) is at least 10.

12. A method for preparing a ready-to-use composition, comprising the steps of mixing a composition according to claim 1 with water to a final water content of from 75 to 99.99 wt %.

13. A ready-to-use composition obtained by the method of claim 12.

14. A method for the treatment of a plant, comprising contacting said plant with a ready-to-use composition according to claim 13.

15. A method according to claim 14, performed by spraying the ready-to-use composition onto the plant.

16. The concentrated agriculturally active composition of claim 1 further comprising agriculturally acceptable components, wherein a) to d) together constitutes 100 wt % of the total composition and the weight ratio of the at least one agriculturally active ingredient to the at least one cationic surfactant is at most 1:2.

17. The composition according to claim 3, wherein the weight ratio of the at least one agriculturally active ingredient to the at least one cationic surfactant is at most 1:4.

18. The composition according to claim 4 comprising at most 10 wt % water.

19. The composition according to 4 comprising at most 1 wt % water.

20. The A composition according to claim 5 comprising at most 20 wt % surfactants other than quaternary ammonium surfactants.
